(19) United States
(12) Patent Application Publication
(10) Pub. No.: US 2015/0100964 A1
(43) Pub. Date: Apr. 9, 2015

(54) APPARATUS AND METHOD FOR MANAGING MIGRATION OF TASKS BETWEEN CORES BASED ON SCHEDULING POLICY

(71) Applicant: ELECTRONICS AND TELECOMMUNICATIONS RESEARCH INSTITUTE, Daejeon (KR)

(72) Inventors: Gap Joo NA, Daejeon (KR); Yung Joon JUNG, Daejeon (KR); Chae Deok LIM, Daejeon (KR)

(73) Assignee: ELECTRONICS AND TELECOMMUNICATIONS RESEARCH INSTITUTE, Daejeon (KR)

(21) Appl. No.: 14/296,783

(22) Filed: Jun. 5, 2014

(30) Foreign Application Priority Data
Oct. 8, 2013 (KR) 10-2013-0119891

(51) Int. Cl. G06F 9/48

(52) U.S. Cl. CPC G06F 9/4856
USPC 718/102

(57) ABSTRACT

Provided are an apparatus and method for managing migration of tasks between cores based on a scheduling policy, which can provide optimal environments utilizing multiple cores to the tasks with various characteristics. It is possible to schedule tasks in consideration of different characteristics. In particular, it is possible to continuously secure the performance of the multi-core system in an environment for operating a plurality of application programs. It is also possible to optimally utilize all cores of the multi-core system, thereby flexibly handling dynamic variation in characteristics of tasks.

### CROSS-REFERENCE TO RELATED APPLICATIONS

This application claims priority under 35 U.S.C. §119 to Korean Patent Application No. 10-2013-0119891, filed on Oct. 8, 2013, the disclosure of which is incorporated herein by reference in its entirety.

### TECHNICAL FIELD

The present invention relates to an apparatus and method for managing migration of tasks between cores based on a scheduling policy, and more particularly, to an apparatus and method for migrating tasks according to a task scheduling policy 0set for each core in a multi-core system.

### BACKGROUND

In related art, performance of multi-core systems depends on core-based scheduling performance of a scheduler and task-based scheduling performance according to a task migration policy.

That is, tasks performed in related art multi-core systems are allocated CPU resources according to a scheduling policy of the system and also scheduled according to a task migration policy for defining which core should performs a specific task, when the specific task should be migrated from the core to another, and so on. Thus performance of multi-core systems depends on such a task migration policy.

When all tasks are scheduled according to task management policies of multi-core systems, task schedulers need larger storage space in order to store more scheduling overheads and tasks as the number of tasks increases. Thus in order to secure storage space to be used by the task schedulers, the size of memory should be increased. However, there is a limitation in that it costs a great deal to increase the memory size because the memory is expensive.

Accordingly, as shown in FIG. 1, a scheduler of the related art multi-core system manages tasks by setting an execution queue for managing a task for each core and giving a scheduling policy to each execution queue.

In this case, the scheduler of the related art multi-core system establishes the same scheduling policy for each execution queue and manages migration of tasks on the basis of queue loading information obtained by considering the number and priorities of tasks in each execution queue. Such a migration policy is referred to as load balancing.

Furthermore, the characteristics of tasks are various depending on a set of programs and input/output data used in the related art multi-core system.

That is, tasks with various characteristics require allocation of CPU resources simultaneously: some tasks may require fast allocation of CPU resources during a short execution time; and other tasks may require allocation of CPU resources for a long time at a time.

For example, as shown in FIG. 2, the related art multi-core system includes four CPU cores CPU core 0, CPU core 1, CPU core 2, and CPU core 3, which include corresponding execution queues Run-queue 0, Run-queue 1, Run-queue 2, and Run-queue 3, respectively.

Different figures in each execution queue Run-queue 0, Run-queue 1, Run-queue 2, and Run-queue 3 indicate tasks with different characteristics.

The related art multi-core scheduler utilizes a task migration policy to load of each execution queue Run-queue 0, Run-queue 1, Run-queue 2, and Run-queue 3, irrespectively of the characteristics of the tasks.

In particular, the related art multi-core scheduler cannot satisfy requirements of tasks with different characteristics because the same minimum guaranteed execution time and scheduling unit time, which are core elements of a scheduling policy, are set for all cores.

That is, when the related art multi-core scheduler sets the minimum guaranteed execution time to be short, tasks requiring fast responses may have the enhanced performance and tasks requiring computational complexity may have the degraded performance due to frequent scheduling.

As described above, the related art multi-core scheduler manages tasks in each execution queue according to the same scheduling policy, which is given to each execution queue, and thus cannot effectively schedule tasks with various requirements.

Accordingly, there is a limitation in that the related art multi-core system cannot effectively utilize multiple cores to optimize the system performance.

### SUMMARY

Accordingly, the present invention provides an apparatus and method for managing migration of tasks between cores based on a scheduling policy for providing an optimal environment using multiple cores to tasks with various characteristics.

In one general aspect, an apparatus for managing migration of tasks between cores based on a scheduling policy includes: a task characteristic analysis unit configured to analyze and classify characteristics of the tasks based on a resource allocation history about each task in a multi-core system; a core-based scheduling policy setting unit configured to set scheduling policies specialized for the cores in the multi-core system based on the classified characteristics of the tasks; and a scheduling policy-based task migration management unit configured to manage migration policies of the tasks in consideration of the characteristics of the tasks analyzed using the scheduling policies.

In another general aspect, a method of managing migration of tasks between cores based on a scheduling policy includes: analyzing and classifying characteristics of the tasks based on a resource allocation history about each task in a multi-core system; setting scheduling policies specialized for the cores in the multi-core system based on the classified characteristics of the tasks; and managing migration policies of the tasks in consideration of the characteristics of the tasks analyzed using the scheduling policies.

Other features and aspects will be apparent from the following detailed description, the drawings, and the claims.

### BRIEF DESCRIPTION OF THE DRAWINGS

FIG. 1 is a view illustrating a multi-core scheduler in related art.

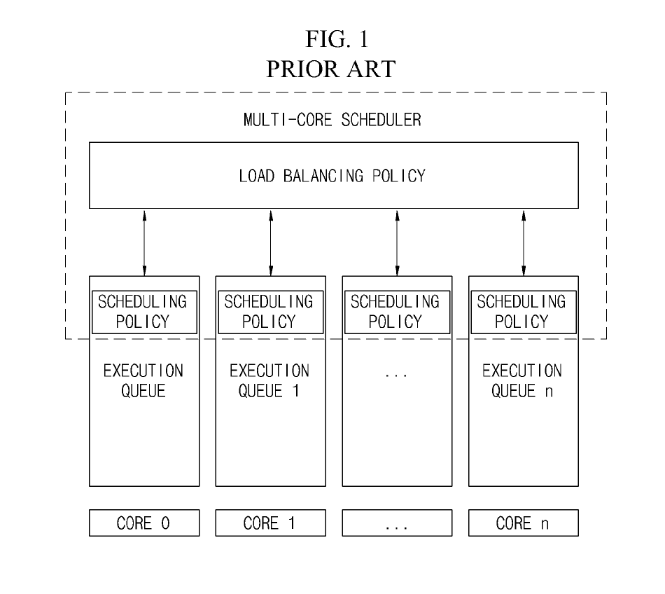

FIG. 2 is a view illustrating scheduling of a multi-core scheduler in related art.

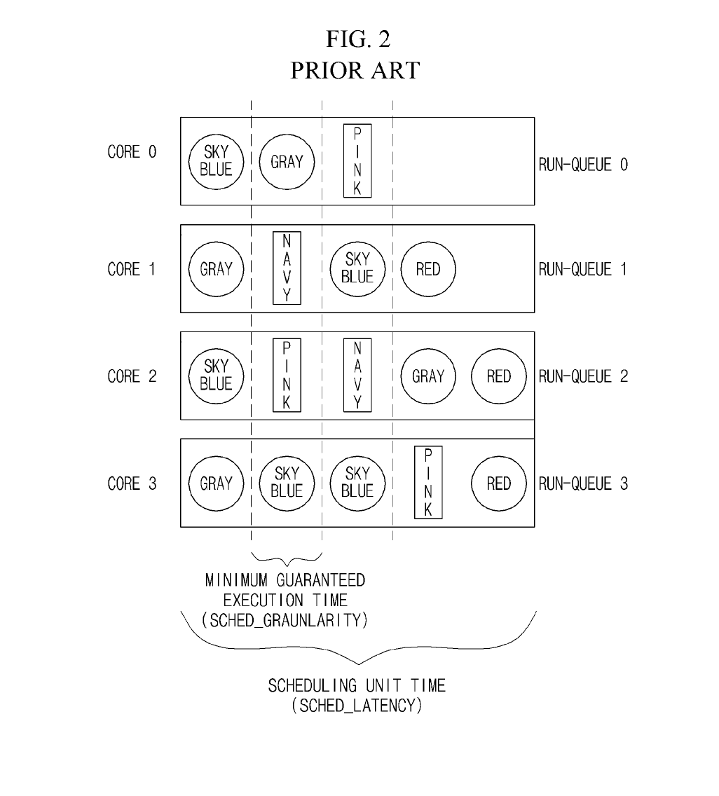

FIG. 3 is a block diagram illustrating an apparatus for managing migration of tasks between cores based on a scheduling policy according to an embodiment of the present invention.

FIG. 4 is a view illustrating scheduling of an apparatus for managing migration of tasks between cores of the present invention.

FIG. 5 is a flowchart illustrating a method of managing migration of tasks between cores based on a scheduling policy according to an embodiment of the present invention.

FIG. 6 is block diagram illustrating a computer system for implementing an apparatus for managing migration of tasks between cores based on a scheduling policy.

### DETAILED DESCRIPTION OF EMBODIMENTS

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” or “comprising,” when used in this specification, specify the presence of stated features, integers, steps, operations, elements, and/or components, but do not preclude the presence or addition of one or more other features, integers, steps, operations, elements, components, and/or groups thereof.

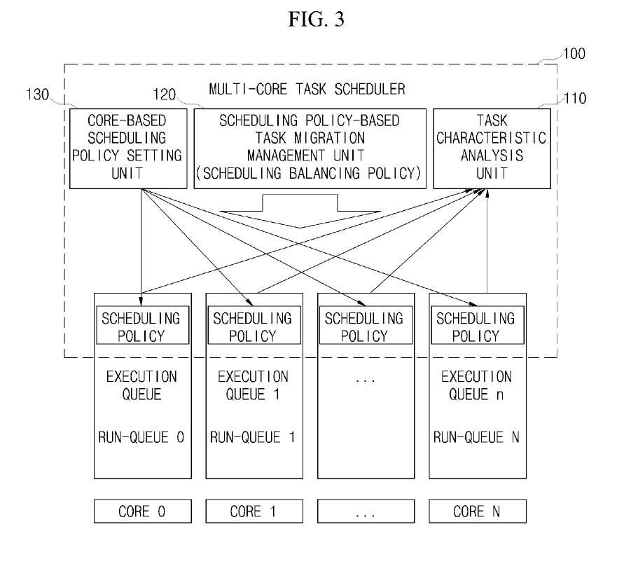

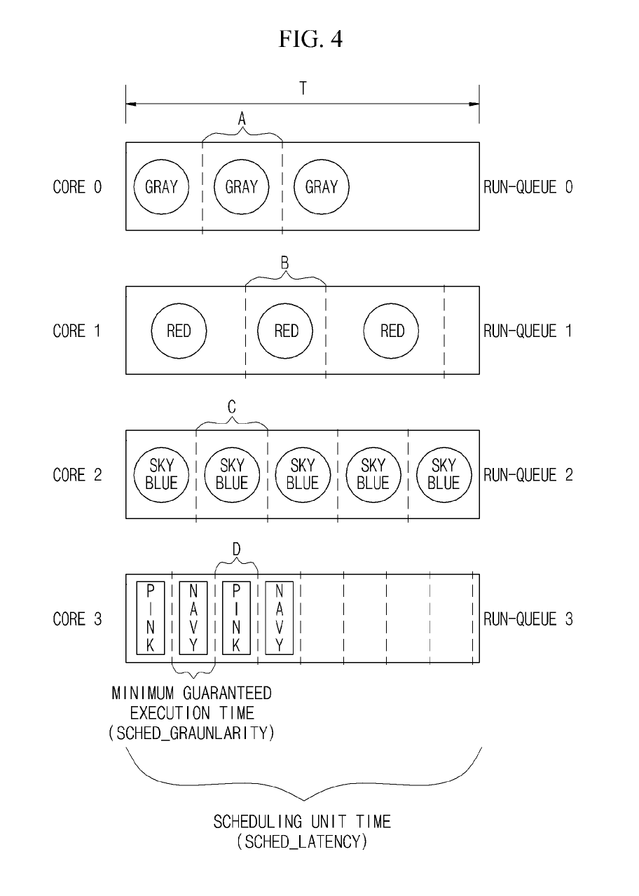

Hereinafter, an apparatus for managing migration of tasks between cores based on a scheduling policy according to an embodiment of the present invention will be described with reference to FIGS. 3 and 4. FIG. 3 is a block diagram illustrating an apparatus for managing migration of tasks between cores based on a scheduling policy according to an embodiment of the present invention, and FIG. 4 is a view illustrating scheduling of an apparatus for managing migration of tasks between cores of the present invention.

As shown in FIG. 3, a multi-core system includes a multi-core task scheduler 100, a plurality of cores CORE 0, CORE 1, . . . , CORE N, and a plurality of execution queues RUN-QUEUE 0, RUN-QUEUE 1 , . . . , RUN-QUEUE N that are set corresponding to the plurality of cores CORE 0, CORE 1, . . . , CORE N.

The multi-core task scheduler 100 may be an apparatus for managing migration of tasks between cores based on a scheduling policy of the present invention or may include an apparatus for managing migration of tasks between cores based on a scheduling policy of the present invention.

The apparatus for managing migration of tasks between cores based on a scheduling policy of the present invention is an apparatus that can give any scheduling policy to each core, and includes a task characteristic analysis unit 110, a scheduling policy-based task migration management unit 120, and a core based scheduling policy setting unit 130.

The task characteristic analysis unit 110 analyzes a characteristic of each task on the basis of a resource allocation (scheduling) history of each task in a multi-core system, classifies the characteristic of each task, and delivers information on the classified characteristic to the scheduling policy-based task migration management unit 120.

Also, as a complexity of an application program executed on the multi-core system continuously increases, a characteristic of each task changes quickly. Thus, when the characteristic of each task are changed, the task characteristic analysis unit 110 analyzes the changed characteristic again and delivers information on the changed characteristic to the scheduling policy-based task migration management unit 120 such that a quick response may be allowed according to the changed characteristic.

For example, when the characteristic of the task is changed from an input/output task that requires a user to perform input/output operations according to a specific context of the multi-core system to a computing task that performs complicated arithmetic operations, the task characteristic analysis unit 110 analyzes the change in characteristic of the task and delivers information on the analyzed change in characteristic to the scheduling policy-based task migration management unit 120 such that the performance of each task may be continuously maintained.

The core-based scheduling policy setting unit 130 sets scheduling policies specialized for the cores CORE 0, CORE 1, . . . , CORE N such that the cores CORE 0, CORE 1, . . . , CORE N may perform the specialized scheduling policies according to the characteristic of the task.

For example, the core-based scheduling policy setting unit 130 may set a scheduling policy, which is intended for a task requiring a fast user response, for CORE 0 such that the task requiring the fast user response may be performed at CORE 0.

More specifically, the core-based scheduling policy setting unit 130 may receive information on a characteristic of each task that is classified by the scheduling policy-based task migration management unit 120 and then set a minimum guaranteed execution time and a scheduling unit time, which are core elements of the scheduling policy, on the basis of the received information on a characteristic of each task such that the cores CORE 0, CORE 1, . . . , CORE N may secure that tasks with different characteristics are provided with optimal operational environments, that is the tasks may operate at the cores having scheduling policies that are optimally suitable for the tasks, respectively.

In addition, the core-based scheduling policy setting unit 130 may set scheduling policies of the cores CORE 0, CORE 1, . . . , CORE N according to a request from the scheduling policy-based task migration management unit 120.

For example, the core-based scheduling policy setting unit 130 sets the same scheduling policy for CORE 0, CORE 1, . . . , CORE N when a request to set the same scheduling policy for CORE 0, CORE 1, . . . , CORE N is received from the scheduling policy based task migration management unit 120 such that tasks with the same characteristic may be performed at CORE 0, CORE 1, . . . , CORE N.

The scheduling policy-based task migration management unit 120 performs migration of tasks currently being executed, according to the scheduling policies set for the cores CORE 0, CORE 1, . . . , CORE N.

For example, the scheduling policy-based task migration management unit 120 manages migration policies for tasks in consideration of information on characteristics of the tasks. For example, migration of a specific task may be determined based on the information on characteristic of tasks that are delivered from the task characteristic analysis unit 110.

That is, the scheduling policy-based task migration management unit 120 migrates each task to a core suitable for the characteristic of the task on the basis of the delivered information on the characteristics of the tasks.

In addition, when the characteristic of the task is changed, in order to quickly respond to the change of the characteristic of the task, the scheduling policy-based task migration management unit 120 performs migration of tasks currently being executed, according to the scheduling policies set for the cores CORE 0, CORE 1, . . . , CORE N on the basis of information on the change of the characteristic of the task which is delivered from the task characteristic analysis unit 110.

Accordingly, when requirements of tasks are changed, the cores CORE 0, CORE 1, . . . , CORE N in the multi-core system may migrate the tasks on the basis of the information on the change of characteristics of the tasks and the scheduling policies, and thus allow each task to continuously operate in an optimal environment.

In addition, when there are a predetermined number or more of tasks with the same characteristic in a specific context of the multi-core system, the scheduling policy-based task migration management unit 120 requests the core-based scheduling policy setting unit 130 to set the same scheduling policy as set for a specific core, for a specific number of cores in order to prevent the predetermined number or more of tasks from being concentrated on only the specific core suitable for the characteristics of the tasks.

As such, according to the present invention, the cores CORE 0, CORE 1, . . . , CORE N may classify the tasks according to the characteristics of tasks required by the multi-core system and then set a scheduling policy for each core such that each task may operate in an optimal environment. If requirements of the tasks are changed, the cores CORE 0, CORE 1, . . . , CORE N allow each task to continuously operating in the optimal environment by giving dynamic scheduling policies to migrate each task.

More specifically, as shown in FIG. 4, the multi-core system includes four cores CORE 0, CORE 1, CORE 2, and CORE 3, four execution queues RUN-QUEUE 0, RUN-QUEUE 1, RUN-QUEUE 2, and RUN-QUEUE 3 corresponding to the cores CORE 0, CORE 1, CORE 2, and CORE 3, respectively, and a plurality of tasks (three gray circles, three red circles, five sky blue circles, three pink rectangles, and two navy rectangles). In this case, the task characteristic analysis unit 110 analyzes characteristics of the plurality of tasks (three gray circles, three red circles, five sky blue circles, three pink rectangles, and two navy rectangles) on the basis of a resource allocation (scheduling) history about the tasks (three gray circles, three red circles, five sky blue circles, three pink rectangles, and two navy rectangles), classifies the characteristics of the tasks (three gray circles, three red circles, five sky blue circles, three pink rectangles, and two navy rectangles), and delivers information on the classified characteristics of the tasks (three gray circles, three red circles, five sky blue circles, three pink rectangles, and two navy rectangles) to the scheduling policy-based task migration management unit 120.

The scheduling policy-based task migration management unit 120 delivers the information on characteristics of the tasks (three gray circles, three red circles, five sky blue circles, three pink rectangles, and two navy rectangles) delivered from the task characteristic analysis unit 110, to the core-based scheduling policy setting unit 130.

The core-based scheduling policy setting unit 130 sets scheduling policy 0 suitable for a characteristic of a task (gray circle) for CORE 0, scheduling policy 1 suitable for a characteristic of a task (red circle) for CORE 1, scheduling policy 2 suitable for a characteristic of a task (sky blue circle) for CORE 2, and scheduling policy 3 suitable for a characteristic of a task (pink rectangle and navy rectangle) for CORE 3 on the basis of the information on characteristics of tasks that is delivered from the scheduling policy-based task migration management unit 120.

For example, the core-based scheduling policy setting unit 130 sets a minimum guaranteed execution time and a scheduling unit time of scheduling policy 0 as (a, T), a minimum guaranteed execution time and a scheduling unit time of scheduling policy 1 as (b, T), a minimum guaranteed execution time and a scheduling unit time of scheduling policy 2 as (c, T), and a minimum guaranteed execution time and a scheduling unit time of scheduling policy 3 as (d, T).

The scheduling policy-based task migration management unit 120 migrates the task (gray circle) to CORE 0, the task (red circle) to CORE 1, the task (sky blue circle) to CORE 2, and the task (pink rectangle and navy rectangle) to CORE 3 on the basis of the information on characteristics (three gray circles, three red circles, five sky blue circles, three pink rectangles, and two navy rectangles) of tasks that is delivered from the characteristic analysis unit 110.

Thus, the present invention may overcome the limitation that the related art multi-core scheduler cannot satisfy requirements of the tasks with different characteristics by setting the same minimum guaranteed execution time and scheduling unit time, which are core elements of a scheduling policy, for all cores, that is, that the related art multi-core scheduler enhances the performance of the tasks requiring fast responses and degrades the performance of the tasks requiring computational complexity due to frequent scheduling when the minimum guaranteed execution time is set to be short.

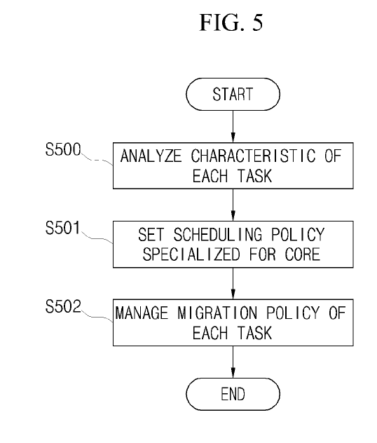

An apparatus for managing migration of tasks between cores based on a scheduling policy according to an embodiment of the present invention has been described with reference to FIGS. 3 and 4. Hereinafter, a method of managing migration of tasks between cores based on a scheduling policy according to an embodiment of the present invention. FIG. 5 is a flowchart illustrating a method of managing migration of tasks between cores based on a scheduling policy according to an embodiment of the present invention.

As shown in FIG. 5, in operation 5500, a method of managing migration of tasks between cores based on a scheduling policy of the present invention analyzes characteristics of tasks on the basis of a resource allocation (scheduling) history of each task in a multi-core system and classifies the characteristics of the tasks.

In addition, when the characteristics of the tasks are changed, the method analyzes the changed characteristics of the tasks again in order to perform fast response according to the change of the characteristics of the tasks.

For example, when the characteristic of the task is changed from an input/output task that requires a user to perform input/output operations according to a specific context of the multi-core system to a computing task that performs complicated arithmetic operations, the method analyzes and classifies the change in characteristic of the task in order to continuously perform maintenance on the performances of the tasks.

In operation S501, the method sets scheduling policies specialized for the cores CORE 0, CORE 1, . . . , CORE N such that the cores CORE 0, CORE 1, . . . , CORE N may perform the specialized scheduling policies according to the characteristic of the tasks.

For example, a scheduling policy, which is intended for a task requiring a fast user response, may be set for CORE 0 such that the task requiring the fast user response may be performed at CORE 0.

More specifically, a minimum guaranteed execution time and a scheduling unit time, which are core elements of the scheduling policy, may be set differently for each core on the basis of the information on a characteristic of each task such that the cores CORE 0, CORE 1, . . . , CORE N may secure that tasks with different characteristics are provided with optimal operational environments, that is the tasks may operate at the cores having scheduling policies that are optimally suitable for the tasks, respectively.

In addition, the same scheduling policy is set for CORE 0, CORE 1, . . . , CORE N when a request to set the same scheduling policy for Core 0, Core 1, . . . , Core N is received such that tasks with the same characteristic may be performed at CORE 0, CORE 1, . . . , CORE N.

In operation S502, the method performs migration of tasks currently being executed, according to the scheduling policies set for the cores CORE 0, CORE 1, . . . , CORE N.

For example, migration policies for tasks are managed in consideration of information on characteristics of the tasks. For example, migration of a specific task may be determined based on the information on characteristic of tasks.

That is, each task is migrated to a core suitable for the characteristic of the task on the basis of the information on the characteristics of the tasks.

In addition, when the characteristic of the task is changed, in order to quickly respond to the change of the characteristic of the task, migration of tasks currently being executed is performed according to the scheduling policies set for the cores CORE 0, CORE 1, . . . , CORE N on the basis of information on the change of the characteristic of the task.

Accordingly, when requirements of tasks are changed, CORE 0, CORE 1, . . . , CORE N in the multi-core system may migrate the tasks on the basis of the information on the change of characteristics of the tasks and the scheduling policies, and thus allow each task to continuously operate in an optimal environment.

In addition, when there are a predetermined number or more of tasks with the same characteristic in a specific context of the multi-core system, a request to set the same scheduling policy as set for a specific core, for a specific number of cores, is made in order to prevent the predetermined number or more of tasks from being concentrated on only the specific core suitable for the characteristics of the tasks.

According to the present invention, it is possible to schedule tasks in consideration of different characteristics.

In particular, it is possible to continuously secure the performance of the multi-core system in an environment for operating a plurality of application programs.

It is also possible to optimally utilize all cores of the multi-core system, thereby flexibly handling dynamic variation in characteristics of tasks.

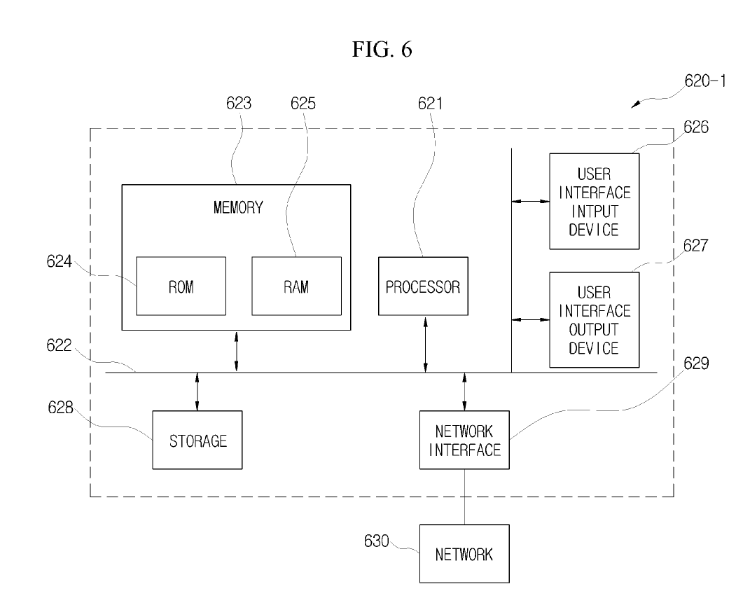

An embodiment of the present invention may be implemented in a computer system, e.g., as a computer readable medium. As shown in FIG. 6, a computer system 620-1 may include one or more of a processor 621, a memory 623, a user input device 626, a user output device 627, and a storage 628, each of which communicates through a bus 622. The computer system 620-1 may also include a network interface 629 that is coupled to a network 630. The processor 621 may be a central processing unit (CPU) or a semiconductor device that executes processing instructions stored in the memory 623 and/or the storage 628. The memory 623 and the storage 628 may include various forms of volatile or non-volatile storage media. For example, the memory may include a read-only memory (ROM) 624 and a random access memory (RAM) 625.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

It should be understood that although the present invention has been described above in detail with reference to the accompanying drawings and exemplary embodiments, this is illustrative only and various modifications may be made without departing from the spirit or scope of the invention. Thus, the scope of the present invention is to be determined by the following claims and their equivalents, and shall not be restricted or limited by the foregoing detailed description.

What is claimed is:

1. An apparatus for managing migration of tasks between cores based on a scheduling policy, the apparatus comprising:
a task characteristic analysis unit configured to analyze and classify characteristics of the tasks based on a resource allocation history about each task in a multi-core system;
a core-based scheduling policy setting unit configured to set scheduling policies specialized for the cores in the multi-core system based on the classified characteristics of the tasks; and
a scheduling policy-based task migration management unit configured to manage migration policies of the tasks in consideration of the characteristics of the tasks analyzed using the scheduling policies.

2. The apparatus of claim 1, wherein, when the characteristics of the tasks are changed according to a context of the multi-core system, the task characteristic analysis unit analyzes the changed characteristics of the tasks and delivers information on the changed characteristics of the tasks to the scheduling policy-based task migration management unit such that the tasks are migrated according to the changed characteristics of the tasks.

3. The apparatus of claim 1, wherein the core-based scheduling policy setting unit sets the scheduling policies specialized for the cores such that the cores in the multi-core system provide optimal operational environments to the tasks with different characteristics.

4. The apparatus of claim 3, wherein the core-based scheduling policy setting unit sets a minimum guaranteed execution time and a scheduling unit time of each of the scheduling polices based on information on the classified characteristics of the tasks to form the scheduling polices specialized for the cores and sets the formed scheduling policies for the cores.

5. The apparatus of claim 1, wherein the core-based scheduling policy setting unit changes a predetermined scheduling policy for each core to a scheduling policy according to a request from the scheduling policy-based task migration management unit.

6. The apparatus of claim 1, wherein the scheduling policy-based task migration management unit determines migration of a specific task based on information on the analyzed characteristics of tasks and scheduling polices for the cores and migrates the specific task to a core suitable for a characteristic of the specific task.

7. The apparatus of claim 6, wherein, when it is determined that the specific task operates at a core not having an optimal scheduling policy, the scheduling policy-based task migration management unit determines migration of the specific task to migrate the specific task to a core having the optimal scheduling policy.

8. The apparatus of claim 1, wherein, when information on the changed characteristics of the tasks is delivered from the task characteristic analysis unit, the scheduling policy-based task migration management unit migrates each task to a core suitable for a changed characteristic of the task based on the delivered information on the changed characteristics of the tasks and the scheduling policies for the cores.

9. The apparatus of claim 8, wherein, when the information on the changed characteristics of the tasks is delivered, the scheduling policy-based task migration management unit determines that the specific task operates at a core not having an optimal scheduling policy to determine migration of the specific task and migrates the specific task to a core having the optimal scheduling policy based on the delivered information on the changed characteristics.

10. The apparatus of claim 1, wherein, when there are a predetermined number or more of tasks with the same characteristic in a specific context of the multi-core system, the scheduling policy-based task migration management unit requests the core-based scheduling policy setting unit to set the same scheduling policy as set for a specific core, for a specific number of cores, in order to prevent the tasks from being concentrated on a specific core according to the characteristics of the tasks.

11. A method of managing migration of tasks between cores based on a scheduling policy, the method comprising:
analyzing and classifying characteristics of the tasks based on a resource allocation history about each task in a multi-core system;
setting scheduling policies specialized for the cores in the multi-core system based on the classified characteristics of the tasks; and
managing migration policies of the tasks in consideration of the characteristics of the tasks analyzed using the scheduling policies.

12. The method of claim 11, wherein the analyzing and classifying comprises, when the characteristic of each task is changed according to a context of the multi-core system, analyzing the changed characteristic of the task.

13. The method of claim 11, wherein the setting of scheduling policies comprises setting the scheduling policies specialized for the cores such that the cores in the multi-core system provide optimal operational environments to the tasks with different characteristics.

14. The method of claim 13, wherein the setting of scheduling policies comprises:
setting a minimum guaranteed execution time and a scheduling unit time of each of the scheduling polices based on information on the classified characteristics of the tasks to form the scheduling polices specialized for the cores; and
setting the formed scheduling policies for the cores.

15. The method of claim 11, wherein the setting of scheduling policies comprises changing a predetermined scheduling policy for each core to a scheduling policy according to a request to manage migration of the tasks.

16. The method of claim 11, wherein the managing of migration policies comprises:
determining migration of a specific task based on information on the analyzed characteristics of tasks and scheduling polices for the cores; and
migrating the specific task to a core suitable for a characteristic of the specific task.

17. The method of claim 16, wherein, when it is determined that the specific task operates at a core not having an optimal scheduling policy, the managing of migration policies comprises determining migration of the specific task to migrate the specific task to a core having the optimal scheduling policy.

18. The method of claim 11, wherein, when information on the changed characteristics of the tasks is delivered, the managing of migration policies comprises migrating each task to a core suitable for a changed characteristic of the task based on the delivered information on the changed characteristics of the tasks and the core-based scheduling policies.

19. The method of claim 18, wherein, when the information on the changed characteristics of the tasks is delivered, the migrating comprises:
determining that the specific task operates at a core not having an optimal scheduling policy to determine migration of the specific task; and
migrating the specific task to a core having the optimal scheduling policy based on the delivered information on the changed characteristics.

20. The method of claim 11, wherein, when there are a predetermined number or more of tasks with the same characteristic in a specific context of the multi-core system, the managing of migration policies comprises making a request to set the same scheduling policy as set for a specific core, for a specific number of cores, in order to prevent the tasks from being concentrated on a specific core according to the characteristics of the tasks.
